(19) United States
(12) Patent Application Publication
(10) Pub. No.: US 2025/0162306 A1
(43) Pub. Date: May 22, 2025

(54) IMAGE PROCESSING DEVICE AND IMAGE PROCESSING METHOD

(71) Applicant: MIMAKI ENGINEERING CO., LTD., Nagano (JP)

(72) Inventors: Keita Nishio, Nagano (JP); Shinyeong Gwon, Nagano (JP)

(73) Assignee: MIMAKI ENGINEERING CO., LTD., Nagano (JP)

(21) Appl. No.: 18/728,887

(22) PCT Filed: Jan. 19, 2023
(86) PCT No.: PCT/JP2023/001478

§ 371 Date: Jul. 14, 2024

(30) Foreign Application Priority Data
Jan. 20, 2022 (JP) 2022-007259

(51) Int. Cl. B41J 2/005; B41J 2/01; B41J 2/21; B41M 3/00; B41M 3/12; G06K 15/02

(52) U.S. Cl. CPC B41J 2/0057; B41J 2/2114; B41M 3/006; B41M 3/12; G06K 15/1852; G06K 15/1878; G06K 15/1881; B41J 2002/012

(57) ABSTRACT

An image processing device and an image processing method are provided. The image processing device includes: a generation unit that generates foil transfer data representing an ejection region of the adhesive ink in a predetermined color with respect to image data indicating an image to be printed on the recording medium; and a composition unit that composes the foil transfer data and the image data to generate composite image data, in which when printing is performed on the recording medium, the adhesive ink is ejected to the region of the predetermined color in the composite image data. The image processing method includes: a first step of generating the foil transfer data; a second step of generating the composite image data; and a third step of ejecting the adhesive ink to a region of a predetermined color in the composite image data and transferring the foil to the recording medium.

### TECHNICAL FIELD

The present invention relates to an image processing device and an image processing method.

### BACKGROUND ART

Some printing apparatuses perform foil transfer printing in which an image is printed on a recording medium using an inkjet printer and foil is transferred to the recording medium to decorate the recording medium.

In a printing apparatus that performs foil transfer printing, a configuration for transferring foil to a recording medium is generally not in-line with a printer. For this reason, the foil is transferred to the recording medium using a roller or a press machine after the image is printed, and a device for transferring the foil is separately required.

For example, Patent Literature 1 describes a method in which a stamp foil is transferred to a substrate by a UV curing adhesive ejected from an inkjet printer and pressed by a roller. However, since the method described in Patent Literature 1 uses a UV curing adhesive, a UV light source is required.

Therefore, an apparatus has also been developed in which an adhesive (hereinafter, referred to as “adhesive ink”) produced using a solvent instead of a UV curing adhesive is ejected from an inkjet head to transfer foil to a recording medium.

### CITATION LIST

### Patent Literature

Patent Literature 1: Japanese Patent No. 6899372

### SUMMARY OF INVENTION

### Technical Problems

In a printing apparatus using adhesive ink, foil transfer is performed by ejecting the color ink onto the recording medium, drying the color ink, and ejecting adhesive ink onto a portion to which the foil has been transferred.

However, when the adhesive ink is ejected on top of the color ink, the foil transferred onto the color ink may be raised up, and thus the design may be impaired. Depending on the type of color ink, the adhesive ink may not be fixed on the color ink, and the foil may not be transferred onto the color ink.

Therefore, an object of the present invention is to provide an image processing device and an image processing method capable of more reliably transferring foil to a recording medium without impairing the design.

### Solutions to Problems

An image processing device according to one aspect of the present invention is an image processing device for performing a foil transfer printing on a recording medium using an ejection unit that ejects an ink for printing an image on the recording medium and an adhesive ink for transferring a foil to the recording medium, the image processing device including: a generation unit configured to generate a foil transfer data representing an ejection region of the adhesive ink in a predetermined color with respect to an image data indicating an image to be printed on the recording medium; and a composition unit configured to compose the foil transfer data and the image data to generate a composite image data, in which when printing is performed on the recording medium, the adhesive ink is ejected to the region of the predetermined color in the composite image data.

According to this configuration, the image data indicating an image to be printed on the recording medium and the foil transfer data indicating an ejection region of the adhesive ink for transferring the foil to the recording medium are composed. As a result, since the adhesive ink is directly ejected onto the recording medium, the foil is directly transferred onto the recording medium. Therefore, this configuration can more reliably transfer the foil to the recording medium without impairing the design.

In the image processing device, the foil transfer data may be represented by a single color of a predetermined color, the adhesive ink may be set as a spot color, and the composition unit may be configured to convert the single color in the foil transfer data into the spot color. According to this configuration, the user can create the foil transfer data as a normal image data without using a special software.

In the image processing device described above, in the foil transfer data, an inside of the ejection region of the adhesive ink may be represented by a predetermined pattern. According to this configuration, since the foil is transferred to the recording medium in a predetermined pattern, the foil can be prevented from becoming cracked after being transferred to the recording medium.

In the above-described image processing device, the predetermined pattern may be halftone dots, and at least one of a diameter of the halftone dots and a density of the halftone dots may be arbitrarily set. According to this configuration, the transfer state of the foil can be adjusted according to the image to be printed on the recording medium or the recording medium.

In the image processing device described above, in the foil transfer data, a color for ejecting the ink may be set in a gap in which the predetermined pattern is not formed. According to this configuration, the recording medium can be colored so as to fill the gap between the pieces of foil transferred in a predetermined pattern, and decorativeness can be further enhanced.

In the image processing device, the foil transfer data may be generated by extracting a contour of a part of an image included in the image data and representing an inside of the contour in the predetermined color. According to this configuration, a user can easily create the foil transfer data.

The image processing device may include a mask processing unit configured to perform a mask processing on the ejection region of the adhesive ink in the composite image data, and the ejection unit may not eject the ink to the ejection region of the adhesive ink on which the mask processing has been performed when performing printing on the recording medium. According to this configuration, the color ink and the adhesive ink are ejected onto the recording medium without overlapping each other, and the printing speed can be increased.

An image processing method according to one aspect of the present invention is an image processing method for performing a foil transfer printing on a recording medium using an ejection unit that ejects an ink for printing an image on the recording medium and an adhesive ink for transferring a foil to the recording medium, the image processing method including: a first step of generating a foil transfer data representing an ejection region of the adhesive ink in a predetermined color with respect to an image data indicating an image to be printed on the recording medium; a second step of generating a composite image data by composing the foil transfer data and the image data; and a third step of ejecting the adhesive to the region of the predetermined color in the composite image data and transferring the foil to the recording medium.

### Effect of the Invention

An object of the present invention is to provide an image processing device and an image processing method capable of more reliably transferring foil to a recording medium without impairing design.

### BRIEF DESCRIPTION OF THE DRAWINGS

FIG. 1 is a schematic configuration diagram of a printing system according to a first embodiment.

FIG. 2 is a schematic diagram of foil transfer printing according to the first embodiment.

FIG. 3 is a schematic cross-sectional view of a recording medium on which a color ink and an adhesive ink of the first embodiment are ejected.

FIG. 4 is a schematic diagram of halftone dot data according to the first embodiment.

FIG. 5 is a schematic diagram of halftone dot data according to the first embodiment.

FIG. 6 is a functional block diagram related to foil transfer printing according to the first embodiment.

FIG. 7 is a flowchart illustrating a flow of print data generation processing of the first embodiment.

FIG. 8 is a flowchart illustrating a flow of foil transfer printing processing of the first embodiment.

FIG. 9 is a schematic view in a case where the nozzle of the inkjet head is virtually divided.

FIG. 10 is a schematic diagram of mask processing according to the first embodiment.

FIG. 11 is a schematic view of foil transfer printing according to a second embodiment.

FIG. 12 is a functional block diagram related to foil transfer printing according to the second embodiment.

FIG. 13 is a flowchart illustrating a flow of print data generation processing of the second embodiment.

FIG. 14 is a schematic view illustrating a texture of another embodiment.

### DESCRIPTION OF EMBODIMENTS

### First Embodiment

Hereinafter, a printing system 10 according to an embodiment of the present invention will be described with reference to the drawings.

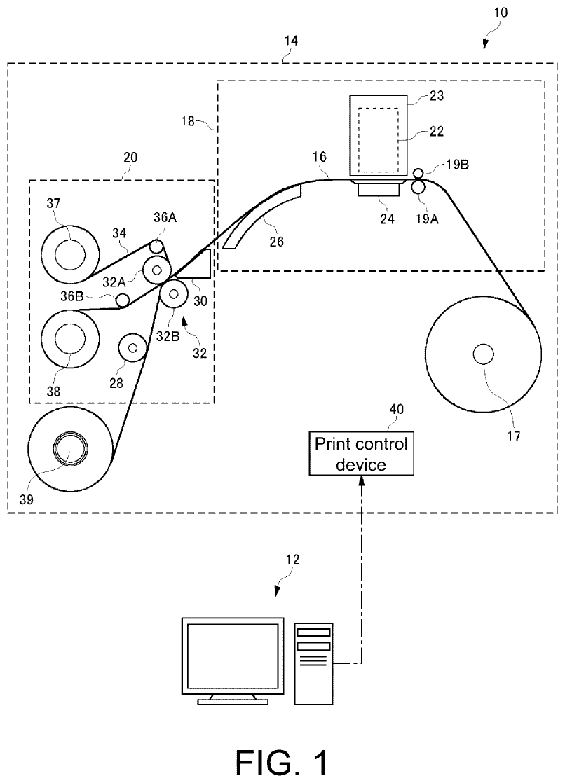

FIG. 1 is a schematic configuration diagram of a printing system 10 of the present embodiment. The printing system 10 includes an information processing apparatus 12 and a printing apparatus 14.

The information processing apparatus 12 is a computer operated by a user, and includes, for example, a monitor, a central processing unit (CPU), a random access memory (RAM), a read only memory (ROM), a computer-readable storage medium, and the like. The information processing apparatus 12 according to the present embodiment functions as an image processing device that generates image data or the like indicating an image to be printed on a recording medium 16 and performs various types of processing on the image data. Furthermore, the information processing apparatus 12 transmits the image data after the image processing to the printing apparatus 14.

The printing apparatus 14 of the present embodiment includes an inkjet printer 18 and a foil transfer device 20 so that foil transfer printing can be performed on a recording medium 16.

The inkjet printer 18 includes an inkjet head 22, a platen 24, and a first heater 26.

The inkjet head 22 ejects process color inks (hereinafter, the ink is referred to as “color ink”) such as yellow, magenta, cyan, and black based on the image data and performs printing on the recording medium 16 placed on the platen 24. Furthermore, the inkjet head 22 of the present embodiment can eject an adhesive ink for transferring (adhering) foil 34 to the recording medium 16. The recording medium 16 is fed out from a medium feeding portion 17 and conveyed to the platen 24 via a conveyor roller 19A and a pad roller 19B. The medium feeding portion 17 holds the recording medium 16 wound in a roll shape. The medium feeding portion 17 does not include a drive source that rotates the recording medium 16, and the recording medium 16 rotates following the conveyance of the recording medium 16 by the conveyor roller 19A. The pad roller 19B is disposed to face the conveyor roller 19A, and is biased toward the conveyor roller 19A.

The inkjet head 22 is mounted on the carriage 23, and ejects the color ink and the adhesive ink based on the image data while moving in a direction (main scanning direction) orthogonal to the conveyance direction (sub scanning direction) of the recording medium 16. The color ink and the adhesive ink of the present embodiment are solvent inks, and the adhesive ink is set as a spot color. The color ink and the adhesive ink may be ultraviolet (UV) ink instead of solvent ink.

The recording medium 16 is, for example, paper, fabric, a resin film, or the like, and is conveyed from the inkjet printer 18 to the foil transfer device 20 without interruption by the conveyor roller 19A or the like.

The first heater 26 is disposed downstream of the inkjet head 22 in the conveyance direction of the recording medium 16, and heats the recording medium 16 to a first temperature (60° C. or higher) to dry the color ink and the adhesive ink. The recording medium 16 in which the color ink and the adhesive ink are dried by the first heater 26 is conveyed as it is to the foil transfer device 20. The heating by the first heater 26 volatilizes the solvent in the color ink and the adhesive ink, so that the color ink and the adhesive ink are dried. By drying the color ink and the adhesive ink by the first heater 26, the color ink and the adhesive ink are fixed at the landing position on the recording medium 16.

The foil transfer device 20 includes a second heater 30 and a foil transfer portion 32.

The second heater 30 is disposed downstream of the first heater 26 in the conveyance direction of the recording medium 16. The second heater 30 heats the recording medium 16 to a second temperature (about 50° C. or higher and lower than 60° C.) lower than a first temperature that is a heating temperature of the first heater 26 to soften the adhesive ink ejected on the recording medium 16.

While the adhesive ink is softened and thickened by heating by the second heater 30, the color ink is not softened. Thus, the color ink and the adhesive ink of the present embodiment have different adhesiveness (softening property and drying property) with respect to temperature. For example, the color ink and the adhesive ink are inks having different softening properties by containing resins having different glass transition temperatures. Furthermore, the color ink and the adhesive ink may be inks having different drying properties due to different drying solvents being contained.

The foil transfer portion 32 is disposed downstream of the second heater 30 in the conveyance direction of the recording medium 16, and transfers the foil 34 to the recording medium 16. The foil transfer portion 32 of the present embodiment is a pair of rollers 32A and 32B. The foil 34 is formed in a sheet shape on the base material, and the foil 34 is fed out from a foil feeding portion 37 and conveyed to the foil transfer portion 32 by a conveyor roller 36A. The color of the foil 34 transferred to the recording medium 16 is not limited. The foil feeding portion 37 holds the foil 34 wound in a roll shape, and rotates following the movement of the foil 34 wound by a foil winding portion 38 after the transfer to the recording medium 16.

The foil 34 and the recording medium 16 conveyed to the foil transfer portion 32 are sandwiched and pressurized by the pair of rollers 32A and 32B. In the recording medium 16 conveyed to the foil transfer portion 32, the adhesiveness of the color ink is lost, while the adhesive ink has adhesiveness. As a result, the foil 34 is peeled off from the base material in the region where the adhesive ink is ejected, and the foil 34 is transferred to the recording medium 16. The foil 34 remaining on the base material after being transferred to the recording medium 16 by the foil transfer portion 32 is guided in a predetermined direction by a guide roller 36B and wound by the foil winding portion 38.

In the present embodiment, the second heater 30 is provided between the first heater 26 and the foil transfer portion 32, but heating for softening the adhesive ink and pressurization for foil transfer may be simultaneously performed by interiorly mounting the heaters on the rollers 32A and 32B of the foil transfer portion 32.

The recording medium 16 to which the foil 34 has been transferred is sent to the medium winding portion 39 by a guide roller 28 for guiding the recording medium 16 in a predetermined direction, and is wound by a medium winding portion 39. Note that the recording medium 16 may not be wound by the medium winding portion 39, and may be cut and ejected from the printing apparatus 14 every time printing is completed. Furthermore, the recording medium 16 on which the foil transfer printing has been completed may be subjected to lamination processing or the like after being ejected from the printing apparatus 14.

Further, the printing apparatus 14 includes a print control device 40 that controls the printing apparatus 14. The print control device 40 includes a CPU, a RAM, a ROM, a computer-readable storage medium, and the like.

The print control device 40 of the present embodiment controls the inkjet head 22 to print an image on the recording medium 16 on the basis of the image data after the image processing transmitted from the information processing apparatus 12. The print control device 40 controls the rotation of the conveyor roller 19A, the foil winding portion 38, the medium winding portion 39, and the like, and controls the temperatures of the first heater 26 and the second heater 30.

In the conventional foil transfer printing, when the adhesive ink is ejected on the color ink in an overlapping manner, the foil 34 is transferred onto the color ink by being raised, so that the design may be impaired. Furthermore, depending on the type of color ink, even if the adhesive ink is ejected onto the color ink, the adhesive ink may not be fixed, and the foil 34 may not be able to be transferred onto the color ink.

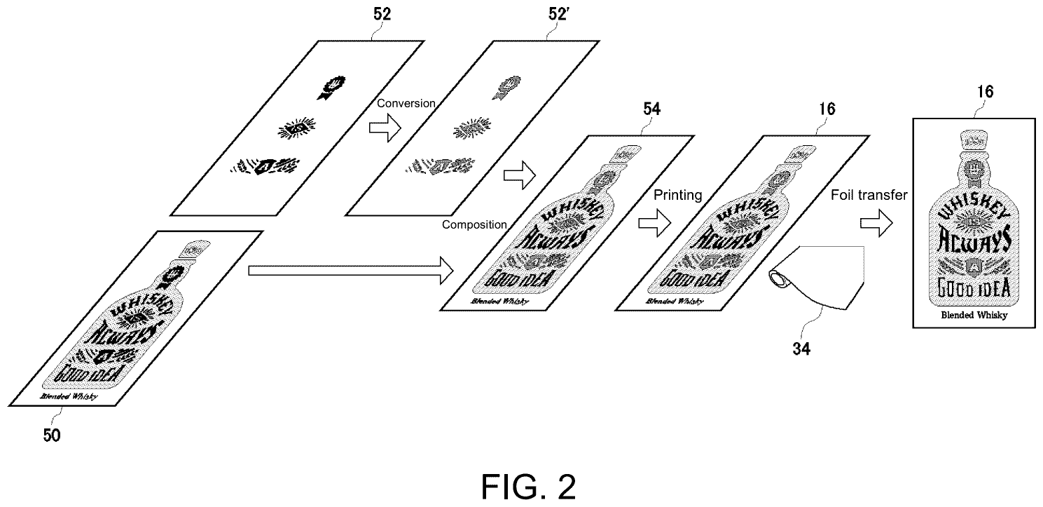

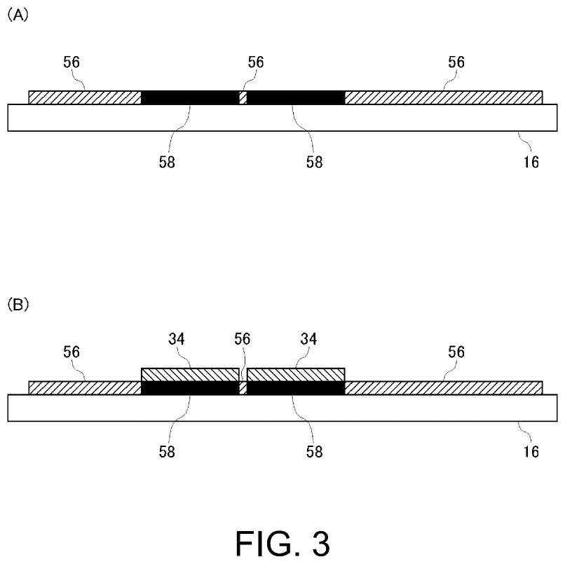

On the other hand, the printing apparatus 14 of the present embodiment can more reliably fix the adhesive ink to the recording medium 16 as described below with reference to FIGS. 2 and 3.

The information processing apparatus 12 according to the present embodiment generates image data 50 indicating an image to be printed on the recording medium 16 and foil transfer data 52 indicating an ejection region of the adhesive ink in a predetermined color. Then, the information processing apparatus 12 composes the foil transfer data 52 and the image data 50 to generate composite image data 54. In other words, the composition means that the region of the image data 50 corresponding to the ejection region of the adhesive ink indicated by the foil transfer data 52 is replaced with the foil transfer data 52.

As described above, in the present embodiment, the foil transfer data 52 is represented by a single color of a predetermined color (for example, black), and the adhesive ink is treated as a spot color. Therefore, the printing system 10 converts the single color in the foil transfer data 52 into the spot color and generates foil transfer data 52′, and composes the foil transfer data 52′ and the image data 50. In this manner, by generating the foil transfer data 52 in a single color and performing processing of converting the single color into a spot color, the user can create the foil transfer data 52 as normal image data without using special software as described below in detail.

In the example of FIG. 2, the image data 50 and the foil transfer data 52 have the same vertical and horizontal sizes. Accordingly, image data 50 and foil transfer data 52 can be composed without performing special alignment. Note that the present invention is not limited thereto, and the foil transfer data 52 may be smaller than the image data 50. In this case, a region where foil transfer data 52 is composed with image data 50 is set in advance.

FIG. 3 is a schematic cross-sectional view of the recording medium 16 on which color ink 56 and adhesive ink 58 are ejected based on the composite image data 54. In the present embodiment, since the image data 50 and the foil transfer data 52 are composed, not only the color ink 56 but also the adhesive ink 58 is directly ejected onto the surface of the recording medium 16 as illustrated in (A) of FIG. 3. As a result, as illustrated in (B) of FIG. 3, the foil 34 is transferred only onto the adhesive ink 58. That is, in the present embodiment, since the foil 34 is directly transferred to the recording medium 16, the printing apparatus 14 of the present embodiment can transfer the foil 34 more reliably without impairing the design.

Here, the foil 34 transferred to the recording medium 16 may have defects such as cracking. This defect is caused by ejecting the adhesive ink 58 to the entire region of a certain level or more and transferring the foil 34 to the entire region.

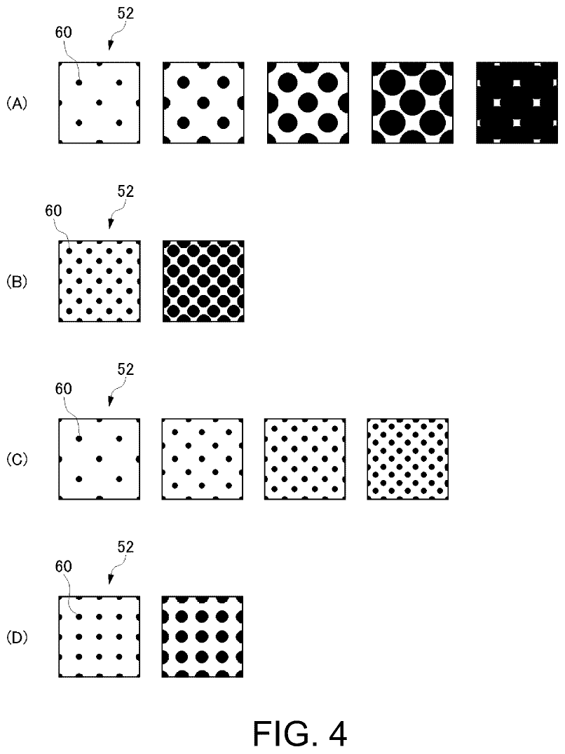

Therefore, in the printing apparatus 14 of the present embodiment, the foil 34 is transferred to the recording medium 16 in a predetermined pattern shape by ejecting the adhesive ink 58 in a predetermined pattern. The predetermined pattern of the present embodiment is halftone dots 60 as an example. That is, as illustrated in FIG. 4, the foil transfer data 52 is generated as image data in which the inside of the ejection region of the adhesive ink 58 is represented by the halftone dots 60 which are dots. Then, the print control device 40 controls the inkjet head 22 to eject the adhesive ink 58 to the position of the halftone dots 60.

Although halftone dots 60 are applied as the predetermined pattern in the present embodiment, this is an example, and other patterns may be used. In the following description, a pattern including halftone dots 60 is referred to as a texture.

FIG. 4 is an example of foil transfer data 52 having halftone dot pattern, and as illustrated in (A) to (D) of FIG. 4, at least one of the size of halftone dots 60 and the density of halftone dots 60 can be arbitrarily set. The density of the halftone dots 60 is the filling rate with respect to the entire ejection region of the adhesive ink 58. As a result, the transfer state of the foil 34 can be adjusted according to the image to be printed on the recording medium 16 or the recording medium 16.

In the examples of (A) and (B) of FIG. 4, although the number of halftone dots 60 per unit area is the same, the sizes of halftone dots 60 are different from each other. When the sizes of halftone dots 60 increase, the density of halftone dots 60 also increases. In the example of (C) of FIG. 4, although the sizes of halftone dots 60 are the same, the density of halftone dots 60 increases as the number of halftone dots 60 increases. Furthermore, in the examples of (A) to (C) of FIG. 4, the arrangement of halftone dots 60 is 45°, whereas in the example of (D) of FIG. 4, the arrangement of halftone dots 60 is 90°. Note that, although the shape of the halftone dots 60 is circular in the example of FIG. 4, the shape of the halftone dots 60 is not limited thereto, and may be another shape such as a rectangle or a star.

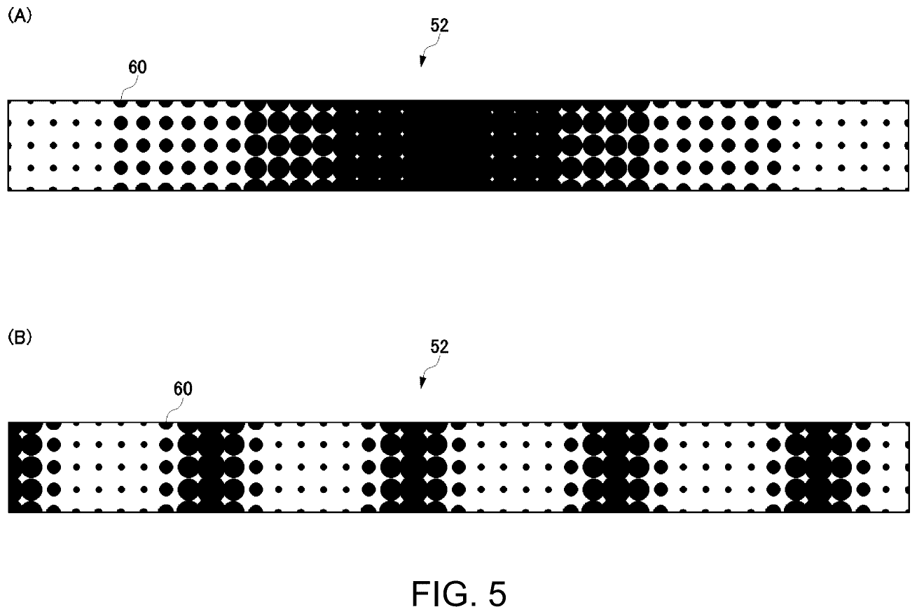

Further, as illustrated in the foil transfer data 52 of FIG. 5, the size and density of the halftone dots 60 may be gradually changed in the ejection region of the adhesive ink 58. In the example of (A) of FIG. 5, the size of the halftone dots 60 gradually increases from the end of the ejection region, and becomes the largest at the central portion of the ejection region. In the example of (B) of FIG. 5, enlargement and reduction of halftone dots 60 are alternately repeated.

As described above, since the printing apparatus 14 of the present embodiment ejects the adhesive ink 58 in halftone dot pattern, the foil 34 is transferred to the recording medium 16 in halftone dot pattern. As a result, since the foil is transferred to the recording medium 16 as a set of a plurality of small pieces of foil 34, it is possible to suppress the foil 34 from being cracked after being transferred to the recording medium 16.

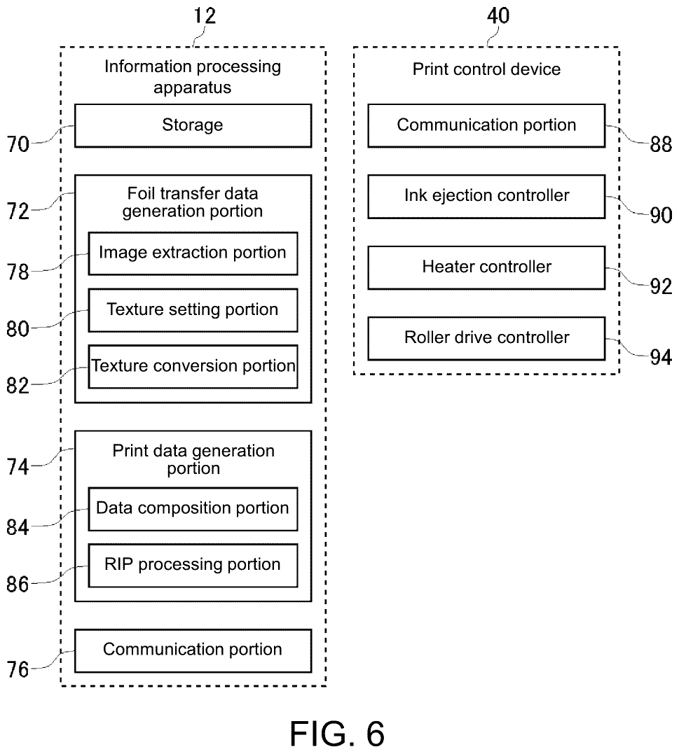

FIG. 6 is a functional block diagram related to foil transfer printing in the printing system 10 of the present embodiment.

The information processing apparatus 12 includes a storage 70, a foil transfer data generation portion 72, a print data generation portion 74, and a communication portion 76.

The storage 70 stores various data and programs such as the image data 50 to be printed on the recording medium 16.

The foil transfer data generation portion 72 generates foil transfer data 52 representing an ejection region of the adhesive ink 58 in a predetermined color according to the image data 50. The foil transfer data generation portion 72 of the present embodiment is general image editing software operated by a user.

The print data generation portion 74 generates print data that is data for printing. The print data generation portion 74 of the present embodiment is dedicated software operated by a user. The print data generation portion 74 composes the image data 50 and the foil transfer data 52, and performs raster image processor (RIP) processing on the composite image data 54. The RIP processing is a process of generating a raster image specifying an ejecting position to which ink of a color corresponding to image data is ejected, and generates a raster image specifying an ejecting position to which ink of the color of gray-scaled image is ejected by performing halftone processing on a gray-scaled image corresponding to each color of the color ink 56 such as C, M, Y, and K and the adhesive ink 58.

The communication portion 76 transmits and receives data to and from the communication portion 88 of the print control device 40 and other information processing apparatuses. Note that the communication portion 76 of the present embodiment transmits the composite image data 54 to the print control device 40.

The foil transfer data generation portion 72 of the present embodiment includes an image extraction portion 78, a texture setting portion 80, and a texture conversion portion 82.

The image extraction portion 78 extracts a contour of a part of the image included in image data 50 as foil transfer data 52. This extraction is, for example, cutting an image region (hereinafter, it is referred to as a “foil transfer region”) to generate foil transfer data 52 from the image data 50. The vertical and horizontal sizes of the foil transfer data 52 are the same as those of the image data 50 as described above, and the position of the extracted foil transfer region is also the same as the position in the original image data 50. In addition, the image extraction portion 78 converts a contour cut as raster data into vector data.

The texture setting portion 80 sets the size of the halftone dots 60 and the density of the halftone dots 60, which are predetermined patterns, according to the user's input. The color of the halftone dots 60 is a predetermined color such as black. The halftone dots 60 is set by, for example, a gradation function included as a function of general image editing software.

The texture conversion portion 82 converts the inside of the contour of the image extracted as the foil transfer data 52 so as to be the halftone dots 60 set by the texture setting portion 80.

As described above, the foil transfer data generation portion 72 of the present embodiment extracts the contour of a part of the image included in the image data 50, and generates the foil transfer data 52 by representing the inside of the contour by the halftone dots 60.

The print data generation portion 74 of the present embodiment includes a data composition portion 84 and an RIP processing portion 86.

The data composition portion 84 composes the foil transfer data 52 and the image data 50 to generate the composite image data 54.

The RIP processing portion 86 performs RIP processing on the image data. Further, the RIP processing portion 86 of the present embodiment performs a mask processing on the ejection region of the adhesive ink 58 in the composite image data 54.

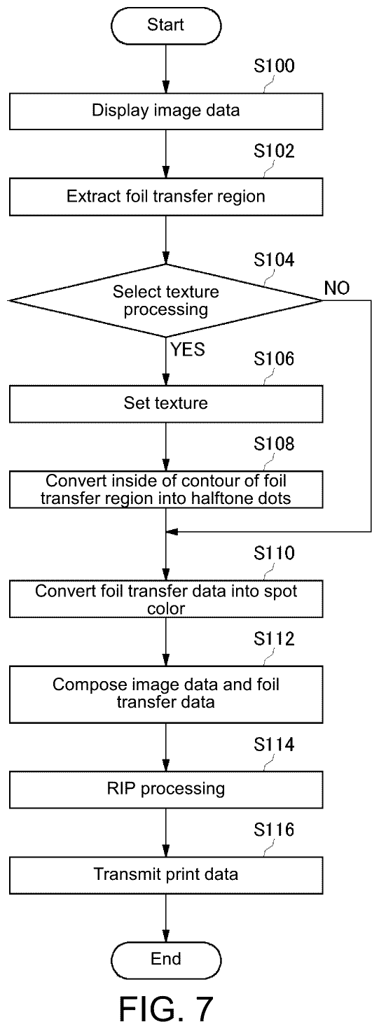

FIG. 7 is a flowchart illustrating a flow of print data generation processing executed by the information processing apparatus 12 of the present embodiment. The foil transfer data generating processing (steps 102 to 108) included in the print data generating processing is performed by a user operating image editing software.

First, in step 100, the image data 50 to be printed on the recording medium 16 is displayed on the monitor.

In next step 102, the image extraction portion 78 extracts the foil transfer region to be foil transfer data 52. Specifically, the user extracts the foil transfer region by cutting out the contour of the foil transfer region to be the foil transfer data 52 from the image data 50 displayed on the monitor. Then, the image extraction portion 78 converts the contour cut by the user from raster data to vector data.

In the next step 104, the user selects whether or not to perform texture processing on the cut foil transfer region. Here, in a case where the texture processing is not performed, the processing proceeds to step 110.

In the next step 106, in a case where the user has selected to perform the texture processing in the previous step 104, the size of the halftone dots 60 and the density of the halftone dots 60 are selected by the user, so that the texture setting portion 80 sets the halftone dots.

In the next step 108, the texture conversion portion 82 converts the inside of the contour of the foil transfer data 52 into halftone dots 60.

In the next step 110, the data composition portion 84 converts the foil transfer data 52 represented by a predetermined color (for example, black) into a spot color to generate foil transfer data 52′.

In the next step 112, the data composition portion 84 composes the image data 50 and the foil transfer data 52′ to generate composite image data 54.

In the next step 114, the composite image data 54 composed by the data composition portion 84 in step 112 is subjected to RIP processing to generate print data.

Here, in printing on the recording medium 16, it is necessary to prevent the adhesive ink 58 and the color ink 56 from overlapping and landing on the recording medium 16.

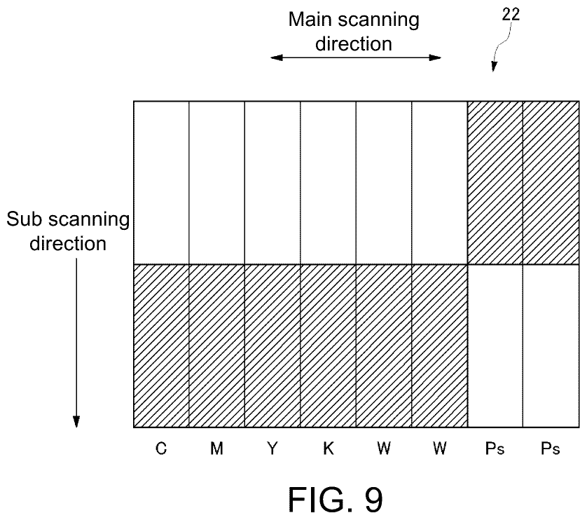

Thus, for example, as illustrated in a schematic diagram of the inkjet head 22 illustrated in FIG. 9, there is an embodiment in which the nozzles that eject the color ink 56 (C, M, Y, K, W) and the nozzles that eject the adhesive ink 58 (Ps) are virtually divided into two in the sub scanning direction, and printing is performed on the recording medium 16. Thus, since the color ink 56 and the adhesive ink 58 are ejected from the nozzles at different positions with respect to the sub scanning direction, the adhesive ink 58 and the color ink 56 can be prevented from overlapping and landing on the recording medium 16.

However, in this method, since only half of the nozzles in the sub scanning direction can be used, the number of movements (passes) of the inkjet head 22 in the main scanning direction is twice as large as when all the nozzles are used.

Therefore, the RIP processing in step 114 includes mask processing on the ejection region of the adhesive ink 58 in the composite image data 54.

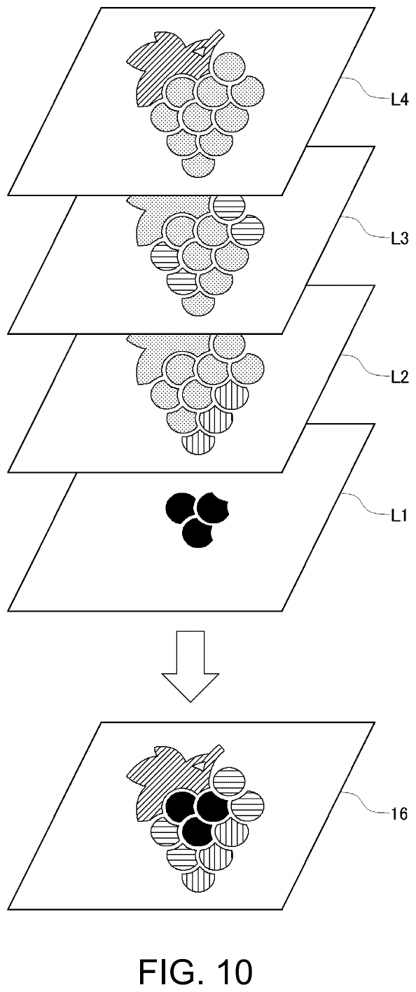

FIG. 10 is a schematic diagram illustrating an example of mask processing. In the example illustrated in FIG. 10, the composite image data 54 includes a plurality of layers L1 to L4, and each layer is formed for each job. The layer L1 corresponds to a job of ejecting the adhesive ink 58 and indicates an ejection region of the adhesive ink 58. The layers L2 to L4 correspond to jobs for ejecting different color inks 56 and indicate ejection regions for different color inks 56.

The mask processing is performed on the layers L2 to L4 except for the ejection region of the color ink 56 corresponding to each layer. The mask processing is performed on a region other than hatching of vertical lines in the layer L2, a region other than hatching of horizontal lines in the layer L3, and a region other than hatching of oblique lines in the layer L4. As described above, by performing the mask processing on each of the layers L2 to L4, the image formed by each of the layers L2 to L4 does not overlap the image formed by the other layers and the ejected adhesive ink 58. Furthermore, the color ink 56 and the adhesive ink 58 can be ejected from the inkjet head 22 using all the nozzles without virtually dividing the nozzles into two.

In the example of FIG. 10, the layer constituting the composite image data 54 is divided for each color ink 56 different from the adhesive ink 58, but the present invention is not limited thereto, and for example, the composite image data 54 may be divided into two layers: a layer of the adhesive ink 58 and a layer of the color ink 56. In this case, in the layer of the color ink 56, the mask processing is performed only on the ejection region of the adhesive ink 58.

In the next step 116, the communication portion 76 transmits the print data to the print control device 40, and ends the print data generation processing.

Next, functions of the print control device 40 will be described. As illustrated in FIG. 6, the print control device 40 includes a communication portion 88, an ink ejection controller 90, a heater controller 92, and a roller drive controller 94.

The communication portion 88 transmits and receives data to and from the information processing apparatus 12, and receives print data from the information processing apparatus 12. That is, the communication portion 88 of the present embodiment functions as acquisition unit that acquire print data generated by the RIP processing.

The ink ejection controller 90 controls the inkjet head 22 to eject the color ink and the adhesive ink 58 onto the recording medium 16 based on the print data.

The heater controller 92 controls the temperatures of the first heater 26 and the second heater 30.

The roller drive controller 94 controls the rotation of various conveyor rollers.

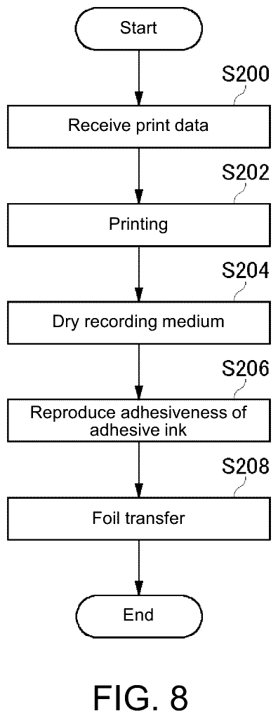

FIG. 8 is a flowchart illustrating a flow of foil transfer printing processing executed by the printing apparatus 14 of the present embodiment.

First, in step 200, the communication portion 88 receives the print data transmitted from the information processing apparatus 12.

In the next step 202, the inkjet head 22 ejects the color ink 56 and the adhesive ink 58 onto the recording medium 16 based on the print data received by the communication portion 88 of the printing apparatus 14 to perform printing on the recording medium 16. As described above, when performing printing on the recording medium 16, the inkjet head 22 does not eject the color ink 56 to the ejection region of the adhesive ink 58 subjected to the mask processing.

As described above, the color ink 56 and the adhesive ink 58 can be ejected using all the nozzles by performing printing on the recording medium 16 based on the print data generated by performing the RIP processing on the mask-processed composite image data 54. Therefore, the color ink 56 and the adhesive ink 58 are ejected onto the recording medium 16 without overlapping and the printing speed becomes faster compared to a case where the inkjet head 22 is divided into two.

In the next step 204, the recording medium 16 is conveyed to the first heater 26, and the first heater 26 dries the color ink 56 and the adhesive ink 58 ejected on the recording medium 16.

In the next step 206, the recording medium 16 is conveyed to the second heater 30, and adhesiveness is generated in the adhesive ink 58 ejected on the recording medium 16.

In the next step 208, the foil 34 is transferred to the recording medium 16 by conveying the recording medium 16 on which adhesiveness is generated in the adhesive ink 58 to the foil transfer portion 32. The recording medium 16 to which the foil 34 has been transferred is ejected from the printing apparatus 14.

### Second Embodiment

Hereinafter, a second embodiment of the present invention will be described.

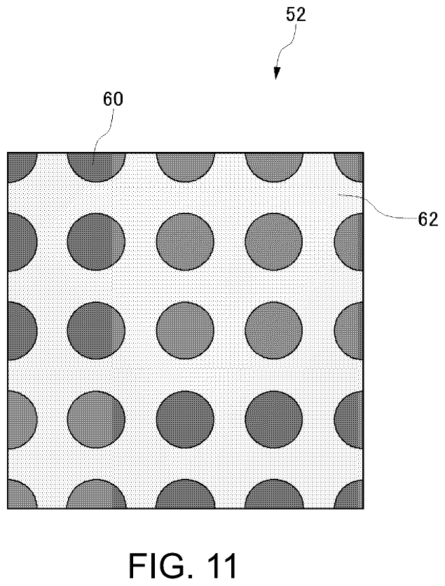

As illustrated in FIG. 11, the information processing apparatus 12 according to the present embodiment prints a color (hereinafter, the color is referred to as a “background color”) set in advance in a gap 62 where halftone dots 60 are not formed in the foil transfer data 52. In the first embodiment, since there is no background color setting, the color ink 56 is not ejected to the gap 62 between the halftone dots 60, and the surface color of the recording medium 16 remains.

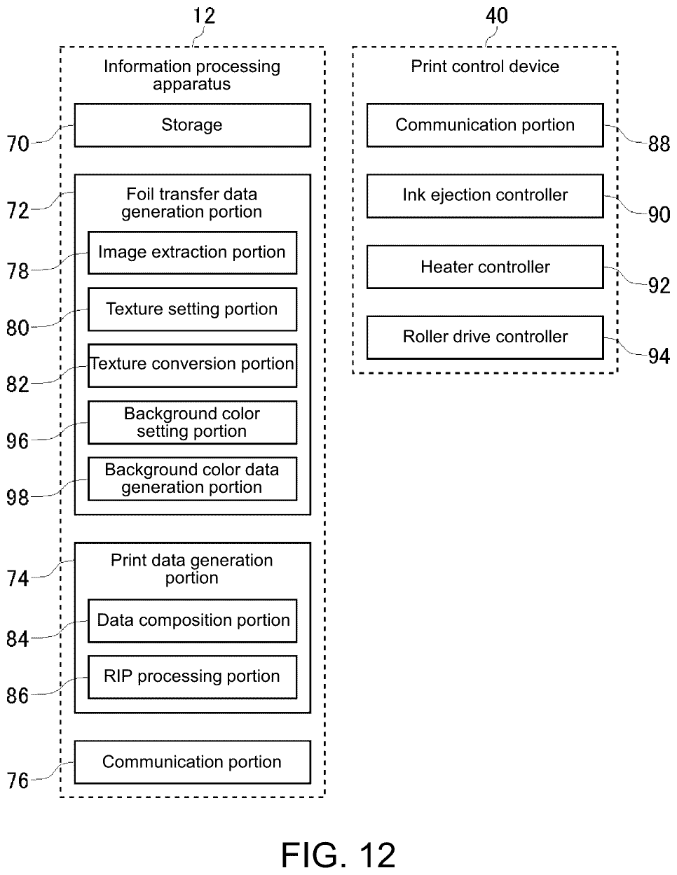

FIG. 12 is a functional block diagram related to foil transfer printing in the printing system 10 of the present embodiment. Note that the same components as those in FIG. 6 illustrated in FIG. 12 are denoted by the same reference numerals as those in FIG. 6, and the description thereof is omitted.

The foil transfer data generation portion 72 of the present embodiment includes a background color setting portion 96 and a background color data generation portion 98.

The background color setting portion 96 sets the background color in accordance with the user's input. Note that the background color is a color that can be arbitrarily set by the user. For example, in a case where the color of the foil 34 is gold, the user sets gold as the background color, but another color may be set as the background color. Furthermore, the background color may be a plurality of colors instead of one color, and gradation may be set.

The background color data generation portion 98 generates background color data on the basis of the set background color. As an example, the background color data is data in which the inside of the contour of the image (ejection region of the adhesive ink 58) in the foil transfer data 52 is represented by a set background color.

The data composition portion 84 included in the information processing apparatus 12 of the present embodiment composes the foil transfer data 52 and the background color data. That is, the foil transfer data 52 illustrated in FIG. 11 is generated by composing background color data. Then, the data composition portion 84 composes the foil transfer data 52 in which the background color is composed and the image data 50 to generate the composite image data 54.

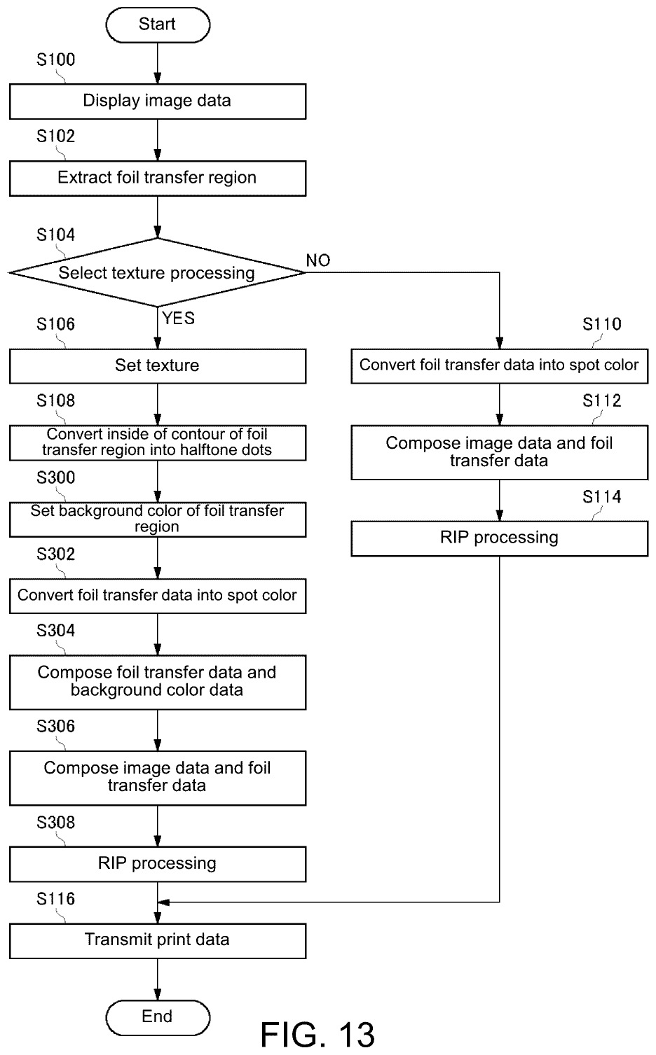

FIG. 13 is a flowchart illustrating a flow of print data generation processing executed by the information processing apparatus 12 according to the present embodiment. Note that the same steps as those in FIG. 7 illustrated in FIG. 13 are denoted by the same reference numerals as those in FIG. 7, and the description thereof will be partially or entirely omitted.

In the print data generation processing of the present embodiment, the inside of the contour of the foil transfer region is converted into halftone dots 60 in step 108, and then the process proceeds to step 300.

In step 300, the background color setting portion 96 sets the background color in the foil transfer region according to the user's input.

In the next step 302, the data composition portion 84 converts the foil transfer data 52 represented in a predetermined color into a spot color to generate the foil transfer data 52′.

In the next step 304, the data composition portion 84 composes the foil transfer data 52′ and the background color data. Here, the composition means that the color of the gap 62 is set based on the background color data with respect to the gap 62 between the halftone dots 60 in the foil transfer data 52′.

In the next step 306, the data composition portion 84 composes the image data 50 and the foil transfer data 52′ to generate composite image data 54. In addition, step 304 and step 306 may be performed as the same step instead of being performed as separate steps. In other words, it is also possible to simultaneously compose the foil transfer data 52, the background color data, and the image data 50.

In the next step 308, the composite image data 54 composed in steps 304 and 306 is subjected to RIP processing to generate print data. Here, the RIP processing in step 308 may be similar to the RIP processing in step 114. The generated print data is transmitted to the print control device 40 in the next step 116.

The printing apparatus 14 performs printing by ejecting the color ink 56 and the adhesive ink 58 on the recording medium 16 based on the print data generated by the information processing apparatus 12. Therefore, the printing apparatus 14 of the present embodiment can color the recording medium 16 so as to fill the gap 62 of the foil 34 transferred in halftone dot pattern, and can further enhance the decorativeness.

Although the present invention has been described with reference to the above embodiments, the technical scope of the present invention is not limited to the scope described in the above embodiments. Various modifications or improvements can be made to the above embodiments without departing from the gist of the invention, and a mode in which the modifications or improvements are made is also included in the technical scope of the present invention. In addition, the above-described embodiments may be appropriately composed.

In the above embodiment, a mode in which the inside of the contour of the image indicated by the foil transfer data 52 is converted into the halftone dots 60 has been described, but the present invention is not limited thereto, and a mode in which the inside of the contour is not converted into the halftone dots 60 may be adopted. In this mode, the entire inside of the contour is a predetermined black color, and the predetermined color is converted into a spot color in the composition of the image data 50 and the foil transfer data 52. As a result, the adhesive ink 58 is ejected entirely within the contour of the image indicated by the foil transfer data 52.

In the embodiment described above, the mask processing is performed so that the adhesive ink 58 and the color ink 56 do not overlap and land on the recording medium 16, but the present invention is not limited thereto. For example, as illustrated in FIG. 9, the nozzles that eject the adhesive ink 58 and the nozzles that eject the color ink 56 may be virtually divided into two, and different nozzles may be used in the sub scanning direction so that the adhesive ink 58 and the color ink 56 do not overlap and land on the recording medium 16.

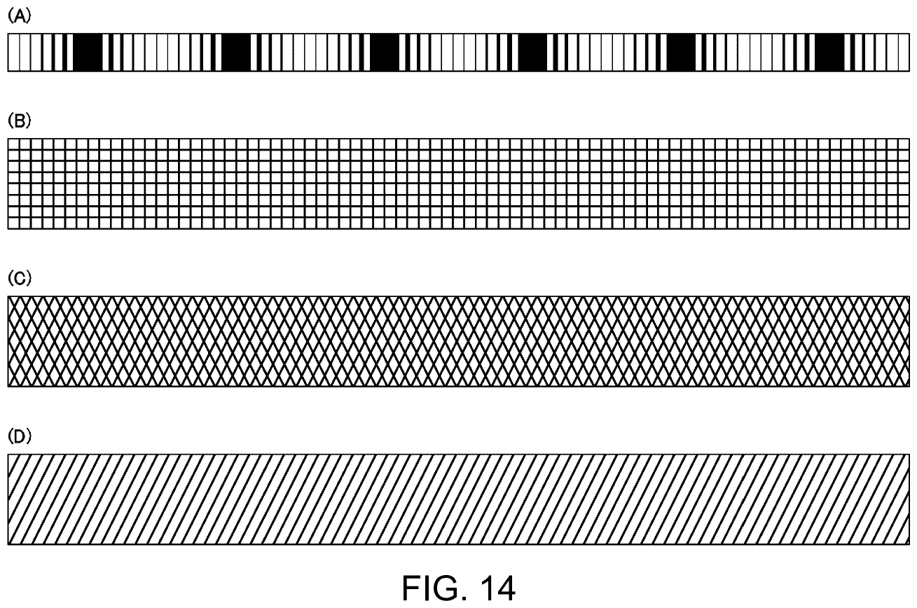

In the embodiment described above, the mode in which the adhesive ink 58 is ejected in halftone dot pattern (dot pattern) as the pattern used for the texture processing has been described, but the present embodiment is not limited to the halftone dot pattern, and the adhesive ink 58 may be ejected so that various patterns such as gradation using lines and halftone lines are expressed by foil transfer as illustrated in (A) to (D) of FIG. 14.

For example, as illustrated in (A) of FIG. 14, when the width of the transfer region of the foil 34 is narrow, the gradient effect may be applied using a pattern formed by lines having different thicknesses instead of the halftone dots 60. In addition, orthogonal lines may be used as a pattern as illustrated in (B) of FIG. 14, or obliquely intersecting lines may be used as a pattern as illustrated in (C) of FIG. 14. Further, as illustrated in (D) of FIG. 14, oblique lines may be used as a pattern. Furthermore, the interval between the lines forming the pattern may be changed.

### Effects of Embodiment

(1) An information processing apparatus 12 according to the present embodiment is a print control device 40 for performing foil transfer printing on a recording medium 16 using an inkjet head 22 that ejects a color ink 56 for printing an image on the recording medium 16 and an adhesive ink 58 for transferring the foil 34 to the recording medium 16, the apparatus including: a foil transfer data generation portion 72 that generates foil transfer data 52 representing an ejection region of the adhesive ink 58 in a predetermined color with respect to image data 50 indicating an image to be printed on the recording medium 16; and a data composition portion 84 that composes the foil transfer data 52 and the image data 50 to generate composite image data 54, in which when printing is performed on the recording medium 16, the adhesive ink 58 is ejected to a region of a predetermined color in the composite image data 54.

According to the present embodiment, the image data 50 indicating the image to be printed on the recording medium 16 and the foil transfer data 52 indicating the ejection region of the adhesive ink 58 for transferring the foil 34 to the recording medium 16 are composed. Accordingly, since the adhesive ink 58 is directly ejected onto the recording medium 16, the foil 34 is directly transferred onto the recording medium 16. Therefore, in the present embodiment, the foil 34 can be more reliably transferred to the recording medium 16 without impairing the design.
(2) In the information processing apparatus 12 of the present embodiment, the foil transfer data 52 is represented by a single color of a predetermined color, the adhesive ink 58 is set as a spot color, and the data composition portion 84 converts the single color in the foil transfer data 52 into the spot color. According to the present embodiment, the user can create the foil transfer data 52 as normal image data without using special software.
(3) In the foil transfer data 52 of the present embodiment, the inside of the ejection region of the adhesive ink 58 is represented by halftone dots 60 in a predetermined pattern. According to the present embodiment, since the foil 34 is transferred to the recording medium 16 in halftone dot pattern, it is possible to suppress the foil 34 from being cracked after being transferred to the recording medium 16.
(4) At least one of the diameter of the halftone dots 60 and the density of the halftone dots 60 of the present embodiment can be arbitrarily set. According to the present embodiment, the transfer state of the foil 34 can be adjusted according to the image to be printed on the recording medium 16 and the recording medium 16.
(5) In the foil transfer data 52 of the present embodiment, a color for ejecting the color ink 56 is set in the gap 62 where the halftone dots 60 are not formed. According to the present embodiment, the recording medium 16 can be colored so as to fill the gap 62 of the foil 34 transferred in halftone dot pattern, and decorativeness can be further improved.
(6) The foil transfer data 52 of the present embodiment is generated by extracting the contour of a part of the image included in the image data 50 and representing the inside of the contour by the halftone dots 60. According to the present embodiment, the user can easily create the foil transfer data 52.
(7) The information processing apparatus 12 of the present embodiment further includes the RIP processing portion 86 that performs the RIP processing including the mask processing on the ejection region of the adhesive ink 58 in the composite image data 54, in which the inkjet head 22 does not eject the color ink 56 to the ejection region of the adhesive ink 58 subjected to the RIP processing when performing printing on the recording medium 16. According to the present embodiment, the color ink 56 and the adhesive ink 58 are ejected onto the recording medium 16 without overlapping, and the printing speed can be increased.

### REFERENCE SIGNS LIST

10 Printing system
12 Information treatment apparatus (image processing device)
16 Recording medium
22 Inkjet head (ejection unit)
34 Foil
40 Print control device
50 Image data
52 Foil transfer data
54 Composite image data
56 Color ink
58 Adhesive ink
60 Halftone dot
72 Foil transfer data generation portion (generation unit)
84 Data composition portion (composition unit)
86 RIP processing portion (mask processing unit)

1. An image processing device for performing a foil transfer printing on a recording medium using an ejection unit that ejects an ink for printing an image on the recording medium and an adhesive ink for transferring a foil to the recording medium, the image processing device comprising:
a generation unit, configured to generate a foil transfer data representing an ejection region of the adhesive ink in a predetermined color with respect to an image data indicating an image to be printed on the recording medium; and
a composition unit, configured to compose the foil transfer data and the image data to generate a composite image data,
wherein when printing is performed on the recording medium, the adhesive ink is ejected to the ejection region of the predetermined color in the composite image data.

2. The image processing device as set forth in claim 1, wherein
the foil transfer data is represented by a single color which is a predetermined color,
the adhesive ink is set as a spot color, and
the composition unit is configured to convert the single color in the foil transfer data into the spot color.

3. The image processing device as set forth in claim 1, wherein
in the foil transfer data, an inside of the ejection region of the adhesive ink is represented by a predetermined pattern.

4. The image processing device as set forth in claim 3, wherein
the predetermined pattern is halftone dots, and
at least one of a diameter of the halftone dots and a density of the halftone dots is capable of being arbitrarily set.

5. The image processing device as set forth in claim 3, wherein
in the foil transfer data, a color for ejecting the ink is set in a gap in which the predetermined pattern is not formed.

6. The image processing device as set forth in claim 1, wherein
the foil transfer data is generated by extracting a contour of a part of an image included in the image data and representing an inside of the contour in the predetermined color.

7. The image processing device as set forth in claim 1, further comprising:
a mask processing unit, configured to perform a mask processing on the ejection region of the adhesive ink in the composite image data,
wherein the ejection unit does not eject the ink to the ejection region of the adhesive ink subjected to the mask processing when performing printing on the recording medium.

8. An image processing method for performing a foil transfer printing on a recording medium using an ejection unit that ejects an ink for printing an image on the recording medium and an adhesive ink for transferring a foil to the recording medium, the image processing method comprising:
a first step of generating a foil transfer data representing an ejection region of the adhesive ink in a predetermined color with respect to an image data indicating an image to be printed on the recording medium;
a second step of generating a composite image data by composing the foil transfer data and the image data; and
a third step of ejecting the adhesive ink to the ejection region of the predetermined color in the composite image data and transferring the foil to the recording medium.

9. The image processing device as set forth in claim 2, wherein
in the foil transfer data, an inside of the ejection region of the adhesive ink is represented by a predetermined pattern.

10. The image processing device as set forth in claim 9, wherein
the predetermined pattern is halftone dots, and
at least one of a diameter of the halftone dots and a density of the halftone dots is capable of being arbitrarily set.

11. The image processing device as set forth in claim 10, wherein
in the foil transfer data, a color for ejecting the ink is set in a gap in which the predetermined pattern is not formed.
